(19) United States
(12) Patent Application Publication
(10) Pub. No.: US 2006/0164497 A1
(43) Pub. Date: Jul. 27, 2006

(54) Needless detection performance correction suppressing image forming apparatus

(76) Inventor: Tadashi Shinohara, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/340,645

(22) Filed: Jan. 27, 2006

(30) Foreign Application Priority Data
Jan. 27, 2005 (JP) 2005-019311

(51) Int. Cl. B41J 2/385; G03G 15/01

(52) U.S. Cl. 347/128; 347/116

(57) ABSTRACT

A color image formation apparatus includes a mark detection device that detects each of marks of a toner pattern, and a positioning operation control device that controls a positioning operation of correcting color deviation by changing write time setting based on the detection result of the mark detection device. The mark detection device reads a background of a conveyance member. A detection performance of the mark detection device is changed in accordance with a stein level of the background so that a prescribed reference level is obtained from the background. A start control device is provided to start the positioning operation when a prescribed positioning operation start condition is met and starts the detection performance correction operation when a prescribed detection performance correction operation start condition different from the positioning operation start condition is met.

### CROSS REFERENCE TO RELATED APPLICATION

This application claims priority under 35 USC § 119 to Japanese Patent Application No. 2005-019311 filed on Jan. 27, 2005, the entire contents of which are hereby incorporated by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to an image formation apparatus, a printing apparatus, a facsimile, and a copier, and in particular to a technology of correcting a detection performance when a plurality of positional deviation patters are formed and a positional deviation caused between component colors is detected and corrected.

2. Discussion of the Background Art

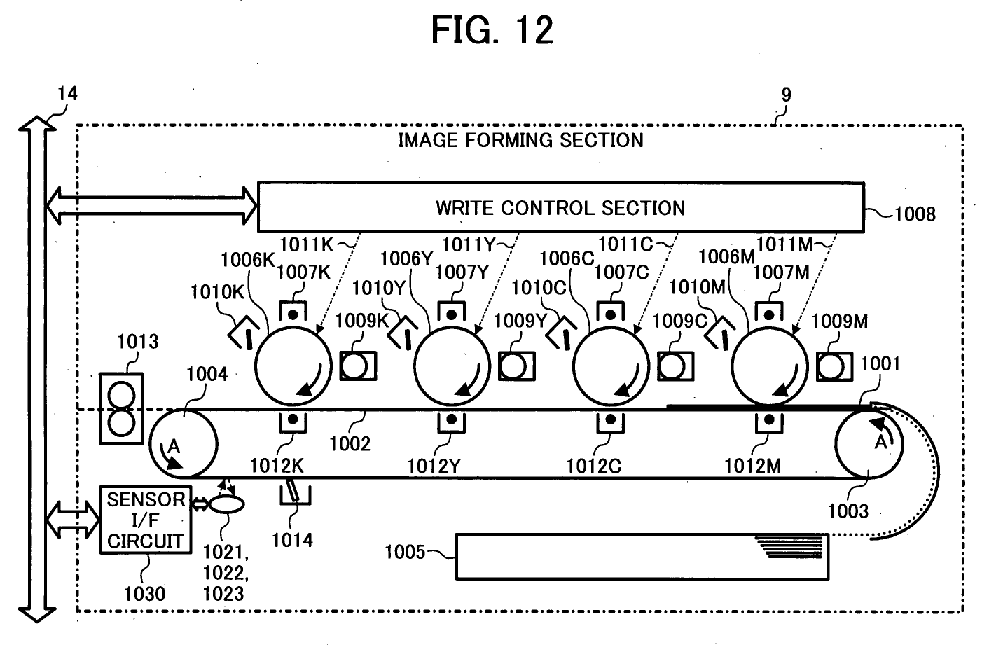

As shown in FIG. 12, a conventional image formation apparatus includes an image formation section 9.

The image formation section 9 is controlled by a control device, such as a CPU, if needed, via a system bus 14, and forms an image using an electro-photographic system. The image formation section 9 is a tandem type in which a plurality of image formation mechanisms are arranged in parallel to each other corresponding to respective color components along with a conveyance belt 1002.

The respective image formation mechanisms of the color components M, C, Y, and K are arranged in parallel to each other on a conveyance belt 1002 that carries and conveys a transfer sheet 1001 in a conveyance belt 1002 running direction.

The conveyance belt 1002 is supported by a driving roller 1003 and a driven roller 1004 to be rotated by the driven roller 1003 in a direction shown by an arrow A. A sheet feeding tray 1005 accommodating a plurality of transfer sheets 1001 is arranged below the surfaces of the conveyance belt 1002 while opposing the surfaces that faces each of the image formation mechanisms of the mono-color components. A uppermost printing sheet among those accommodated therein is fed one by one by a sheet feeding mechanism, not shown, and is attracted to the conveyance belt 1002 as a transfer sheet 1001. The transfer sheet 1001 is conveyed in a sub scanning direction and reaches a position of an image formation mechanism arranged upstream on a conveyance path corresponding to a color component of magenta M. The transfer sheet 1001 is conveyed and passes through the respective image formation mechanisms for color components C, Y, and K.

The image formation mechanism for the component color M includes a photo-conductive drum 1006M driven by a photoconductive drum driving mechanism, not shown, so that its peripheral speed matches with a conveyance speed of the conveyance belt 1002. Also included are a charger 1007M arranged around the photoconductive drum 1006M to uniformly charge a peripheral surface of the photoconductive member, and a write control section 1008 (commonly used by respective color components) forms a latent image on the peripheral surface of the photo-conductive drum by emitting a laser beam modulated in accordance with the mono color image of the color component while erasing the charge including image formation mechanisms for respective mono color images of color components of image data. Also included are a developing device 1009M that forms a toner image on the photoconductive drum 1006M by attracting toner to the latent image, and a photo-conductive member cleaner 1010M that removes the toner or the like remaining on the photoconductive drum 1006M after the toner image is transferred onto the transfer sheet 1001 on the conveyance belt 1002.

Now, the image formation for the color component M is described as time elapses. First, the charger 100M uniformly charges the periphery of the photoconductive drum 1006M. An exposure control section 1008 exposes the peripheral surface of the photoconductive drum 1006M with a mono color laser beam 1011M modulated in accordance with the mono color image of the color component M. Thus, a latent image is formed thereon. The latent image attracts toner and is accordingly developed by the developing device 1009M, thereby a toner image is formed on the photoconductive drum 1006M. The toner image is transferred onto a transfer sheet 1 on the conveyance belt 1002 by a transfer device arranged downstream of a transfer position where the transfer sheet 1 contacts the peripheral of the photoconductive drum 1006M.

Thus, a mono color image (e.g. a magenta image) is formed on the transfer sheet 1. The toner needlessly remaining on the photoconductive drum 1006M after its transferring is cleaned by the photoconductive member cleaner 1007M. Thus, the photoconductive drum 1006M is prepared for the next image formation starting from a charging process by the charger 1007M.

Respectively remaining image formation mechanisms corresponding to mono color components C, Y, and K have substantially the same configurations.

Herein after, it is premised that an alpha numeral X (X=C, Y, K or M) is assigned to an image formation mechanism corresponding to a color component X. A transfer sheet 1001 with a mono color image of color component M from the image formation mechanism M is conveyed by the conveyance belt 1002 (i.e., in a sub scanning direction), and passes through the respective transferring positions of the image formation mechanisms. A plurality of toner images corresponding to image data of the respective color components are superimposed on the transfer sheet 1001. The transfer sheet 1001 passing through the last image formation mechanism K is separated from the conveyance belt 1002, and the toner image is firmly fixed onto the transfer sheet 1001 by the fixing roller heated in the fixing apparatus 1013. Then, the transfer sheet 1001 is ejected.

When image formation of color image data formed from a plurality of color components is executed, times of passing through the respective image formation mechanisms corresponding to the respective colors onto the transfer sheet 1001 generally vary. Thus, a write start time in a sub scanning direction in accordance with a color component in an image formation mechanism, specifically, a start time for emitting a laser beam in accordance with a content of a mono color image of a color component in an exposure control section 1008 need to be adjusted. Specifically, respective color component toner images should precisely be superimposed on the transfer sheet 1001 contacting the conveyance belt 1002 at the respective transfer potions of image formation mechanisms.

The time can be previously calculated from a conveyance speed of the conveyance belt 1002 (i.e., a peripheral speed of the photoconductive drum) and an arrangement positional relation or the like of the photoconductive drum of each color component. However, owing to deterioration of precision of parts attachment of a mechanism and a mutual positional relation, the time can't precisely be calculated both in the main (i.e., a widthwise direction of the conveyance belt 1002) and the sub scanning direction. Thus, an image formation apparatus write time is fixed to that logically calculated based on a positional relation between respective image formation mechanisms corresponding to color components in a tandem type image formation apparatus, color deviation of a superimposed toner image unavoidably occurs on the transfer sheet 1.

Thus, current setting of a write time per a color component need to be corrected appropriately per color component so that deviation between toner images of respective color components superimposed on the transfer sheet 1001 is corrected.

Such correction of the write time is also needed in an indirect transfer system where toner images of respective color components are transferred and superimposed onto a transfer belt and further transferred onto a transfer sheet on a conveyance belt driven in contact with the transfer belt.

To appropriately correct, a practically occurring color deviation is detected and is corrected by correcting write times for respective color components in a direction to resolve the color deviation based on the detection result.

Then, a plurality of detection sensors 1021, 1022, and 1023 are arranged on a transfer surface of the conveyance belt 1002 (a peripheral that contacts respective photoconductive drums for color components) in a main scanning direction (i.e., a width wise direction of the conveyance belt 1002) down stream of image formation mechanisms corresponding to color components so as to detect positioning use pattern in a image formation section 9 of FIG. 12. The respective detection sensors 1021, 1022, and 1023 have the substantially the same configurations, and employ reflection type devices including a light emission element and a light acceptance element that receives a light emitted from the light emitting element and reflected by a transfer surface (i.e., a background) of the conveyance belt 1002. These detection sensors 1021, 1022, and 1023 can employ transmission type devices if the conveyance belt 1002 is made of transparent material.

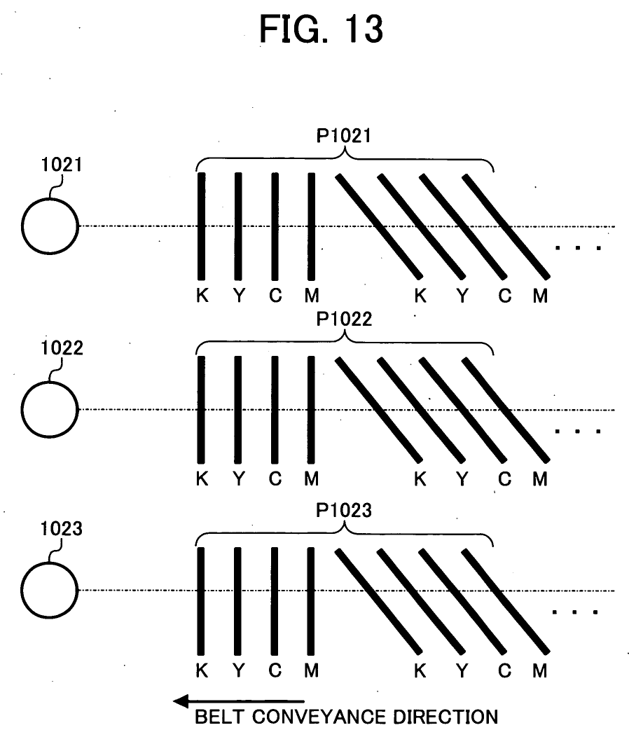

FIG. 13 illustrates a positional relation between these detection sensors 1021, 1022, and 1023 and apart of positioning use toner mark strings P1021, P1022, and P1023, formed on the conveyance belt 1002 of FIG. 12 in accordance with a presently set write time.

A plurality of toner mark strings P1021, P1022, and P1023 having the same patterns are formed at positions are arranged corresponding to the detection sensors 1021, 1022, and 1023.

As typically shown by a toner mark string P1021 corresponding to the detection sensor 1021, four side and slant lines for respective mono color components K, Y, C, and M are formed in a unit. The slant lines convert a deviation in the main scanning direction into that of the sub scanning direction. To improve detection precision, eight units are formed even if only one unit is shown in FIG. 13.

By detecting those side and slant lines with the detection sensors 1021 to 1023, a color deviation among the respective color components in the sub scanning direction (i.e., a deviation of a sub scanning registration), a color deviation of those in the main scanning direction (i.e., a deviation of a main scanning registration), skews of respective color components in relation to a reference color component (e.g. K: black) caused by shaft deviation of photoconductive drums of respective color components, and a magnification error in the main scanning direction can be measured. Thus, an image is shifted in an opposite direction to that of the positional deviation by a half amount of the maximum positional deviation detected by the detection sensors. Specifically, by finely adjusting and shifting the write time from a current setting, both registration deviations in the both main and sub scanning directions, and magnification error in the main scanning direction can be corrected without apparently known.

When these detection sensors 1021 to 1023 complete detection, these positioning use toner mark strings P1021 to P1023 are scraped off from the conveyance belt 1002 by the cleaning device 1014 arranged downstream of the detection sensors. Thus, these positioning use toner mark strings P1021 to P1023 do not interfere formation and detection of following positioning use toner mark strings.

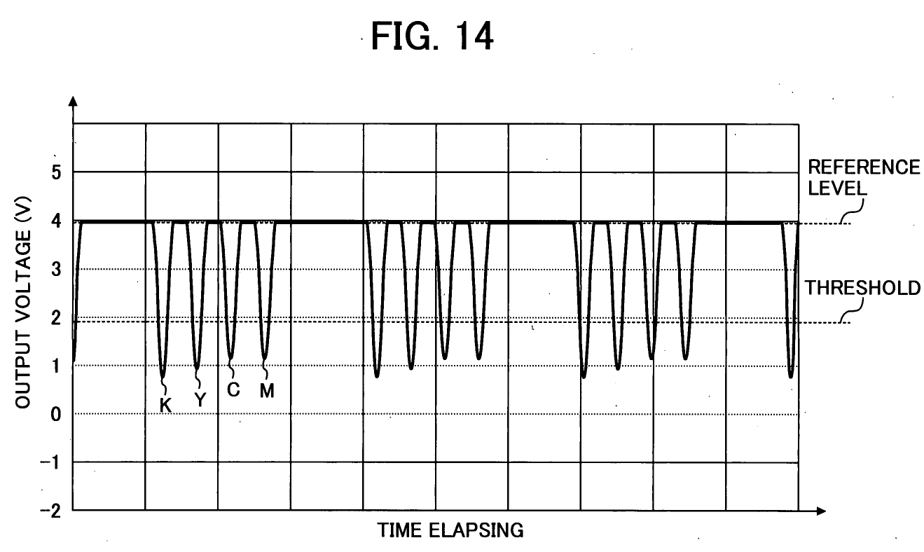

FIG. 14 illustrates a change of an output voltage output from a light acceptance unit when the detection sensors 1021 to 1023 detect the positioning use toner mark strings P1021 to P1023.

Before detection, a detection circuit is calibrated so that an output voltage becomes a prescribed reference level (e.g. about 4 volts) when a background portion of a conveyance belt 1002 is detected. Then, a mark position is determined from a change (a degree of decreasing) in a voltage in a pattern corresponding to each of the color components.

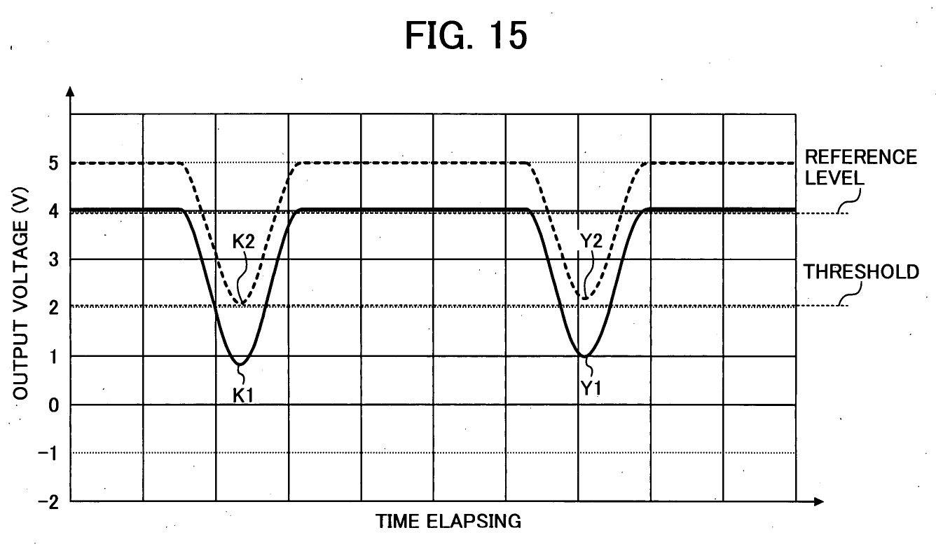

FIG. 15 illustrates detection waves of the patterns corresponding to respective color components K and Y of FIG. 14.

As shown by waves K1 and K2, a detection wave is compared with a prescribed threshold Vth (e.g. 2 volts), and a wave central position is calculated from rising and dropping intersections of the waves.

If the detection circuit is not calibrated so that the background voltage becomes 4 volts, the voltage level does not completely drops to the level Vth (e.g. 2 volts) as shown by the waves K2 and Y2. Thus, since the rising and dropping intersections of the waves do not appear, the wave central position cannot be calculated. Thus, it is essential to detect a mark after correcting the detection circuit so that a background detection level becomes a prescribed reference level (e.g. about 4 volts). Here, it is possible in a sense that a threshold level is changed in accordance with a background detection level. However, when a background detection level significantly decreases (e.g. 1.5 volts), an input voltage range of A/D conversion cannot be fully used and precision of voltage detection deteriorates, and as a result, precision of positional deviation correction decreases. Thus, it is preferable that a detection performance of a detection circuit is corrected so that a background detection level becomes a reference level.

Before a positioning sequential operation in that a positioning use toner pattern is formed and detected, and a write time is corrected, a detection performance of a detection circuit is corrected (hereinafter referee to as a detection performance correction operation) so that a detection level of a background on a conveyance belt 1002 becomes a prescribed reference level in a conventional image formation apparatus.

As one example of a detection performance correction operation as described in Japanese Patent Application Laid Open No. 2003-131443, a plurality of reference pattern images formed on a transfer conveyance belt for density detection and position detection uses are detected by the same reflection type photo-sensors, and a threshold Vth used in positional detection is set based on a background output voltage and the minimum output voltage detected by the density detection. However, in any ways, a prescribed time period is needed to start and execute the detection performance correction operation.

Further, the above-mentioned positioning operation is started and executed when a starting condition of an external factor, such as a start instruction input from a user, that from a service person, that from a printer driver that starts running on a terminal computer using an image formation apparatus, etc., is met. Otherwise, the above-mentioned positioning operation is started and executed when a starting condition of an internal factor, such as meeting of a start condition in its own apparatus, completion a prescribed number of printings, excess of a set temperature range at a prescribed portion that largely affects color deviation in an apparatus, etc.

Then, every time when the start condition of either the external or internal factor is met and the positioning operation is started and executed, the detection performance correction operation is necessarily started and executed.

Further, the above-mentioned detection performance correction operation is effective as a countermeasure to avoid cut and stein on the surface of the belt.

However, since almost these cut and stein gradually grow serious, the detection performance correction operation is not necessarily started and executed at a high frequency together with the positioning operation.

### SUMMARY

Accordingly, an object of the present invention is to address and resolve such and other problems and provides a new image formation apparatus including a write control device that controls a laser beam to form a plurality of latent images of component colors on a plurality of photoconductive members arranged in parallel to each other corresponding to respective component colors based on write time setting information stored in a memory, and a color image formation device that forms a color image by developing the plurality of latent images and transferring and superimposing those either directly onto a transfer sheet conveyed by a conveyance member traveling in a photoconductive member arrangement direction, or indirectly onto a transfer sheet via an intermediate transfer member traveling in the photoconductive member arrangement direction. A positioning use toner pattern forming device is provided form a positioning use toner pattern including a plurality of marks corresponding to the color components on either the conveyance member or the intermediate transfer member. A mark detection device is provided to detect each of the marks forming the positioning use toner pattern. A positioning operation control device is provided to control a positioning operation of correcting color deviation caused between the component colors by changing the write time setting information based on the detection result of the mark detection device. A detection performance correction operation control device is provided to control mark detection device to read a background of either the conveyance member or the intermediate transfer member and correct the detection performance of the mark detection device so as to obtain a prescribed reference voltage level from the background. A start control device is provided to control the positioning operation control device to start the positioning operation when a prescribed positioning operation start condition is met and controls the detection performance correction operation control device to start the detection performance correction operation when a prescribed detection performance correction operation start condition different from the positioning operation start condition is met.

In another embodiment, the mark detection device includes a light emitting element and a light receiving element, said light receiving element receiving a light generated by the light emitting element and reflected by the background, and wherein the detection performance correction operation control device corrects the detection performance of the mark detection device by change intensity of the light emitted by the light emitting element.

In yet another embodiment, an elapsing time threshold storing device is provided to store an elapsing time threshold, and where in the detection performance correction operation start condition is met when the elapsing time threshold has been elapsed after the detection performance correction operation lastly is executed.

In yet another embodiment, an elapsing time threshold storing device is provided to store an elapsing time threshold. Further, the detection performance correction operation start condition is met when the elapsing time threshold has elapsed after the detection performance correction operation is lastly started and the positioning operation start condition is firstly met. Further, the start control device controls the detection performance correction operation control device to operate before starting the positioning operation control device.

In yet another embodiment, a detection performance setting value storing device is provided to store a setting value related to a detection performance. The detection performance is corrected and updated each time when the detection performance correction operation is performed. Further, a threshold elapsing time setting value changing device is provided to compare the currently and previously corrected setting values, and changes the threshold elapsing time in accordance with a difference between those setting values.

In yet another embodiment, a threshold number of pages storing device is provided to store a threshold page number. The detection performance correction operation start condition is met when the threshold page number of images has been formed by the image formation device after the detection performance correction operation is lastly started.

In yet another embodiment, a threshold page number storing device is provided to store a threshold page number. The detection performance correction operation start condition is met when the image formation device has executes the threshold page number of image formation after the detection performance correction operation is lastly executed and the prescribed positioning operation start condition is firstly met. Further, the start control device starts the detection performance correction operation control device to operate before starting the positioning operation control device.

In yet another embodiment, a page number setting value changing device is provided to compare the currently and previously corrected setting values and changes the threshold page number in accordance with a difference between those setting values.

### BRIEF DESCRIPTION OF DRAWIMGS

A more complete appreciation of the present invention and many of the attendant advantages thereof will be readily obtained as the same becomes better understood by reference to the following detailed description when considered in connection with the accompanying drawings, wherein:

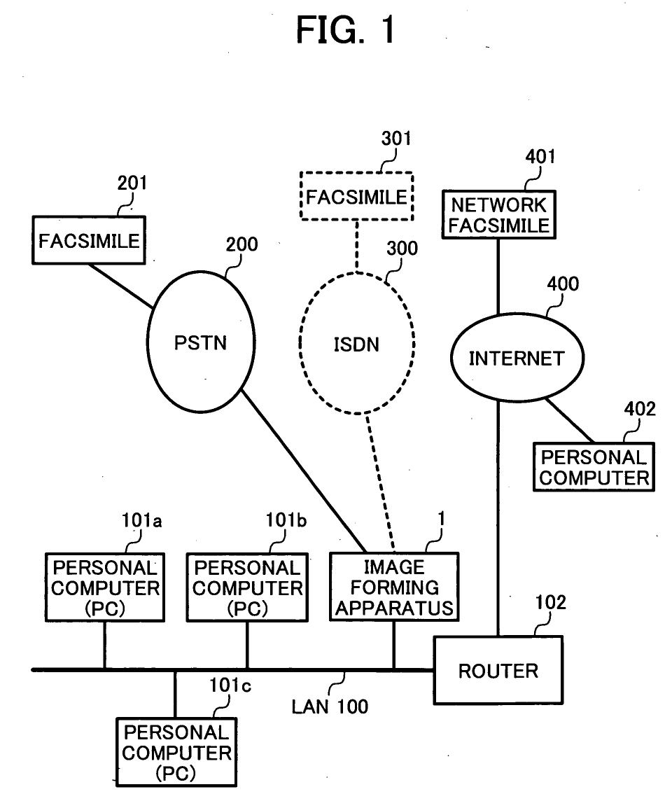

FIG. 1 illustrates an exemplary system that includes an image formation apparatus according to one embodiment of the present invention;

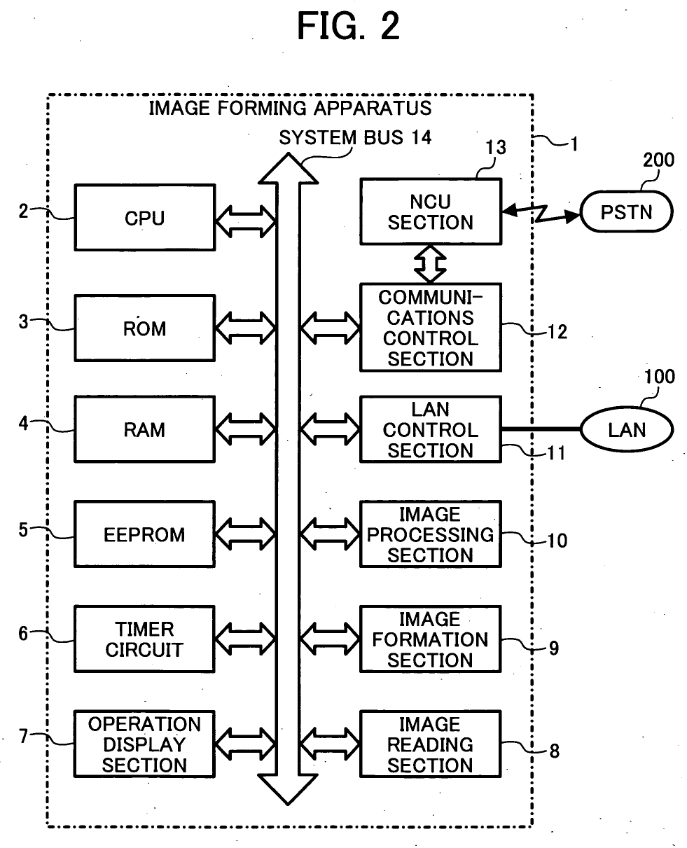

FIG. 2 illustrates exemplary functional blocks of the image formation apparatus of FIG. 1;

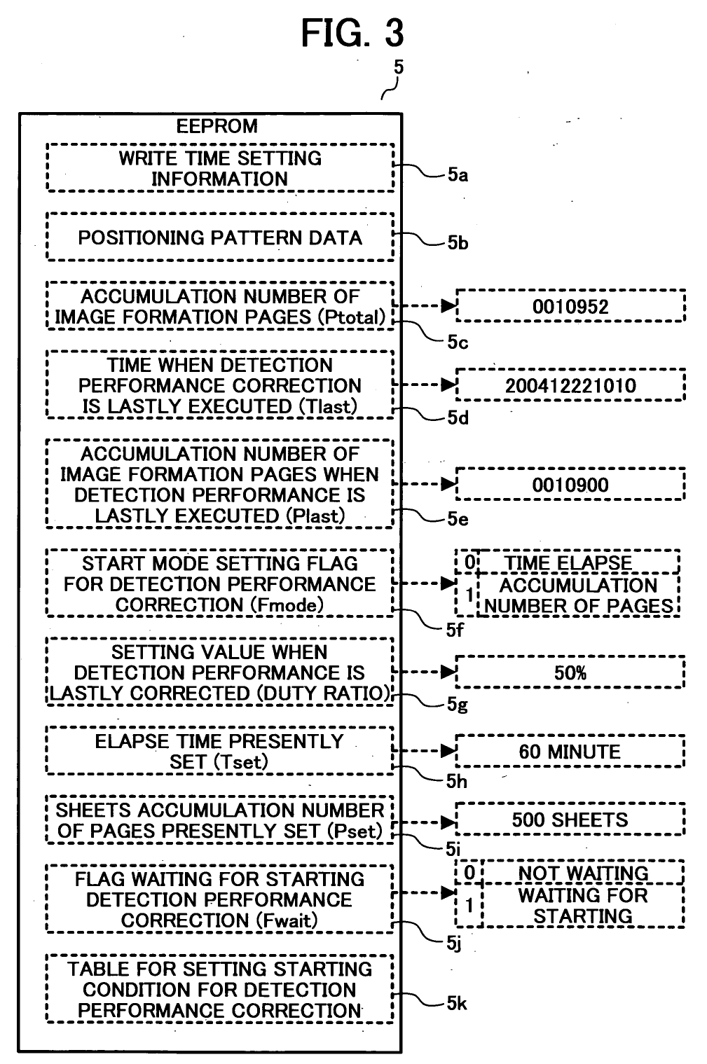

FIG. 3 illustrates exemplary contents stored in an EEPROM included in the image formation apparatus of FIG. 1;

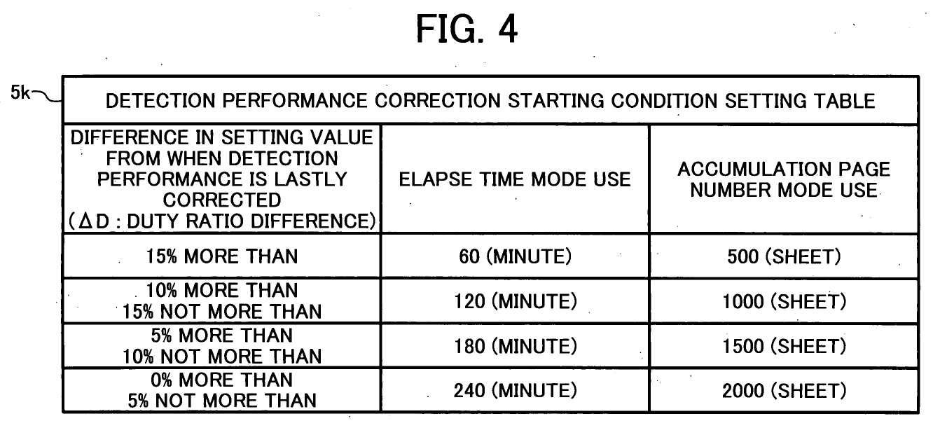

FIG. 4 specifically illustrates exemplary contents of a detection performance correction operation start condition setting table according to one embodiment of the present invention;

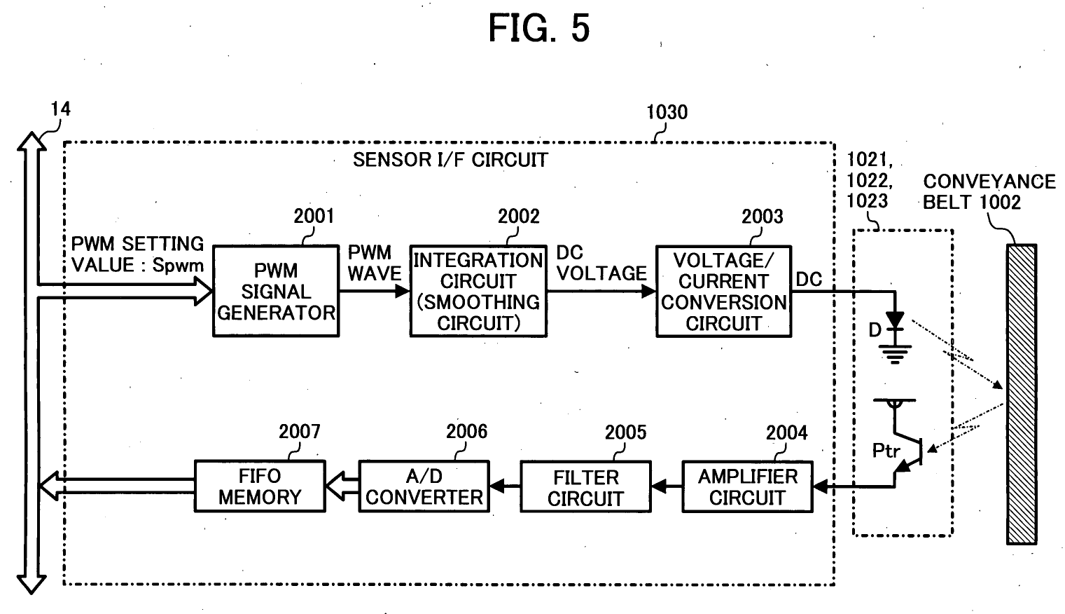

FIG. 5 specifically illustrates an exemplary sensor I/F circuit;

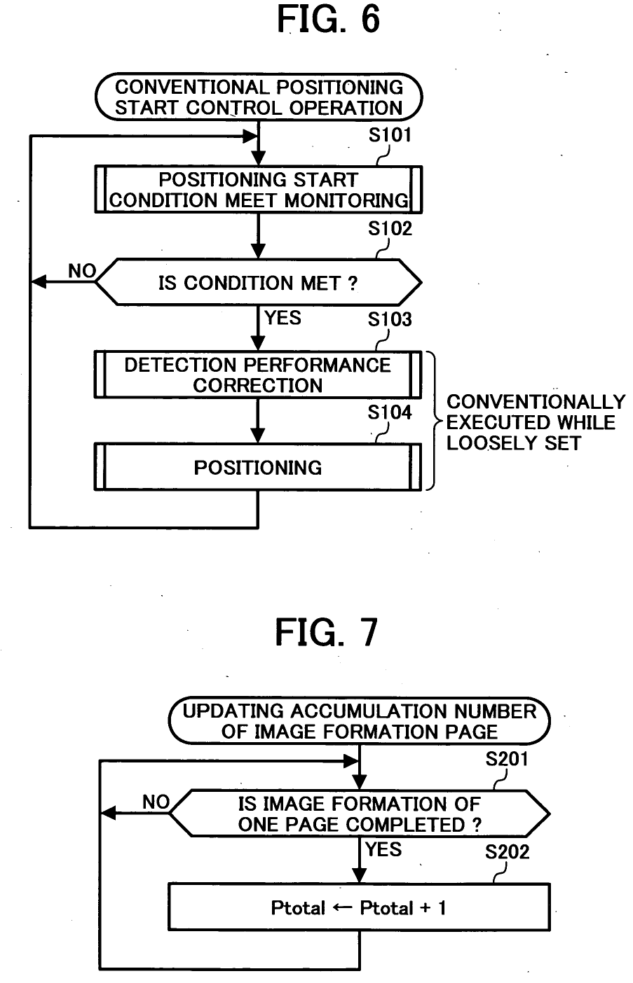

FIG. 6 specifically illustrates a conventional sequence of a positioning operation start control operation;

FIG. 7 specifically illustrates an exemplary sequence of updating an image formation accumulation page number according to one embodiment of the present invention;

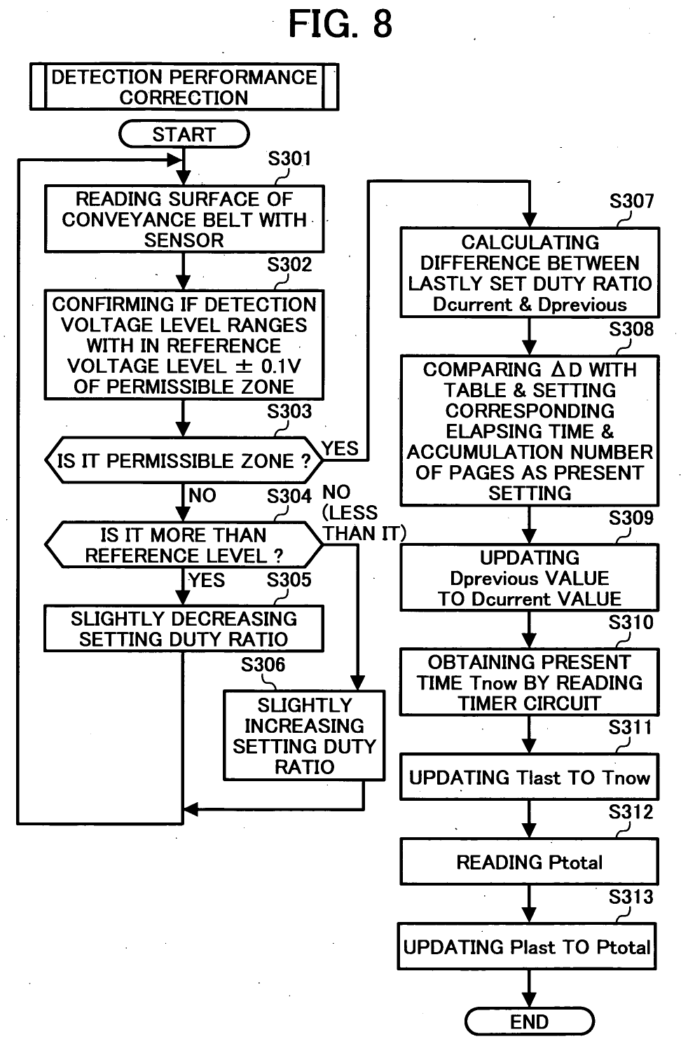

FIG. 8 specifically illustrates an exemplary sequence of a detection performance correction operation;

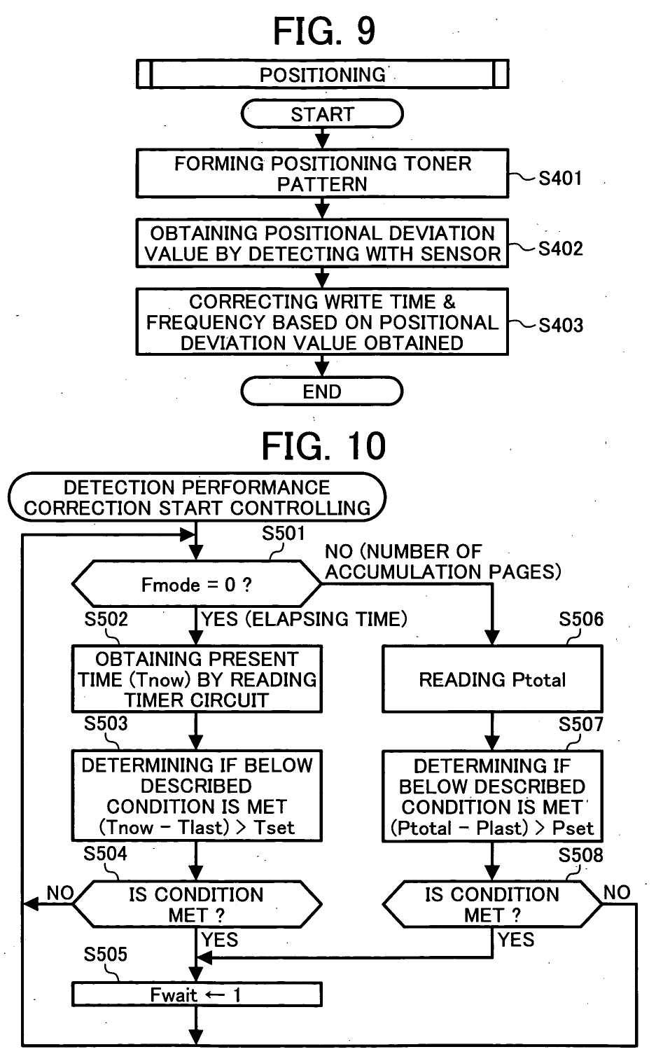

FIG. 9 specifically illustrates an exemplary sequence of a positioning operation according to one embodiment of the present invention;

FIG. 10 illustrates an exemplary sequence of a detection performance correction operation start control operation according to one embodiment of the present invention;

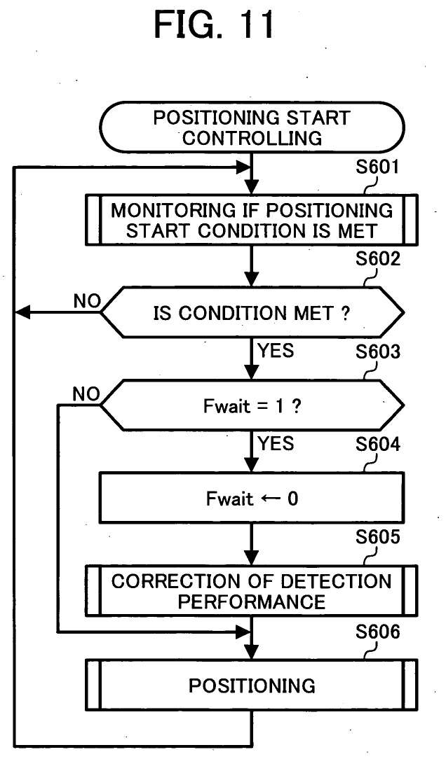

FIG. 11 illustrates an exemplary sequence of positioning operation start controlling according to one embodiment of the present invention;

FIG. 12 illustrates a conventional image formation apparatus to which one embodiment of the present invention is applied;

FIG. 13 illustrates an exemplary position correcting use mark string and an exemplary mark detection sensor according to one embodiment of the present invention;

FIG. 14 illustrates an exemplary voltage wave generated when the mark detection sensor detects the positional correction use mark string according to one embodiment of the present invention; and

FIG. 15 illustrates an exemplary condition in which a level of the voltage wave generated when the mark detection sensor detects the positional correction use mark string changes in accordance with background stein of a belt.

### DESCRIPTION OF THE PREFERRED EMBODIMENTS

Referring now to the drawing, wherein like reference numerals designate identical or corresponding parts throughout several views, in particular in FIG. 1, an exemplary system including an image formation apparatus 1 will be described according to one embodiment of the present invention.

The image formation apparatus 1 is enabled to communicate image data with a facsimile 201 on a PSTN 200 via the PSTN 200. The image formation apparatus 1 can be enabled to communicate image data with a facsimile 301 on an ISDN 300 if the ISDN is employed. Further, the image formation apparatus 1 is connected to a LAN 500 and the Internet 400 via a router 502 that executes packet conversion. Thus, the image formation apparatus 1 is enabled to communicate image data by email with a personal computer 402 on the Internet 400. Further enabled are communications of email and picture data by means of real time network facsimile communications based on the ITU-T recommendation T. 38 with a network facsimile 401 on the Internet 400. Further, the image formation apparatus 1 is enabled to communicate picture data with personal computers 501a, 501b, and 501c or the like on the LAN 500.

Specifically, the image formation apparatus 1 exerts multiple functions of a scanner, a printer, and a copier or the like for a conventional facsimile, a network facsimile, and a personal computer 501a or the like.

Now, each of functional blocks of image formation apparatus 1 is described with reference to FIG. 2.

A CPU 2 uses the RAM 4 as an operation region and functions as a central computing processing apparatus that controls each section of the apparatus and executes various data processing based on control program written in the ROM 3.

A ROM 3 functions as a read only memory that stores control program used by the CPU 2 to control each section of the apparatus and various data, such as font data corresponding to each character code needed for controlling.

A RAM 4 is a random access memory used by the CPU 2 as an operation region as mentioned above.

An EEPROM (e.g. a electrically rewritable private used memory) 5 stores various information needed in operating the apparatus, and maintain storage contents even when power supply for the apparatus is turned off. The EEPROM 5 can be replaced with a backed-up SRAM (static RAM) or magnetic disc apparatus.

A timer circuit 6 always times a present date and time. The present date and time can be known when the CPU 2 reads the timer circuit 6 via a system bus 14.

An operation display section 7 includes various keys for receiving inputs from a user and includes an indicator, such as a LCD apparatus, etc., to display an operation condition and various messages to be notified to a user.

A reading section 8 obtains picture data by reading an original document, and includes a prescribed configuration as mentioned later.

An image formation section 9 prints out image data onto a recording sheet as illustrated in FIG. 12.

An image processing section 10 applies various processing to picture data handled by the image formation apparatus 1, such as coding compression of natural image data, coding and decoding processing for executing decoding expansion for compressed coded data, digitization, magnification, reduction and enlargement processing, image correction processing, reordering processing for a pixel order in each main scanning line that constitutes image data, addition processing for additional information, such as character strings information (e.g. communications dates)

A LAN communications control section 10 includes a NIC (Network Interface Card), and is connected to the LAN 500. Thus, the LAN communications control section 10 enables communications of various data using its upper lank protocol when the CPU 2 communicates TCP/IP protocol on the LAN protocol.

A communication control section 12 is connected to the PSTN 200 via a NCU section 13 and controls communications with the other communication terminal. The communication control section 12 controls the NCU section 13 and detects a pulse of a ringing voltage, detected by the NCU section 13, a DTMF signal, and a tone signal. The communication control section 12 also executes calling at the time of transmission. The communication control section 12 includes a modem, and demodulates modulated data received from the other communication terminal.

The communication control section 12 modulates and transmits data. Specifically, the communication control section 12 includes a low speed modem function (V.21 modem) that communicates G3 facsimile control signals based on ITU-T recommendation T.30 and that of a high-speed modem function V. 17, V. 33, V. 34, V. 29, and V. 27ter that mainly communicates document image data.

The NCU section 13 is connected to the PSTN 200, and closes a line, and detects a call signal (e.g. ringing) or the like.

A system bus 14 is a signal line including a data bus, an address bus, a control bus, and an interruption signal line, used by the above-mentioned respective sections to communicate data.

With the above-mentioned configuration, the image formation apparatus 1 forms and outputs image data onto a recording sheet as one of the printing apparatus, a receiver of the facsimile, and the copier. Image formation is executed by the image formation section 9 as mentioned above.

Exemplary storage contents of the EEPROM of the image formation apparatus 1 are now described with reference to FIG. 3.

As shown, write time setting information is stored in a storage area 5a. The information is used to form respective color component images without color deviation and includes write start time setting information for starting respective color component image writing in both main and sub scanning directions, a frequency setting information for write clock, or the like. These information are set into a write control section 1008 before the image formation section 9 starts image formation. The write control section 1008 controls irradiation of a laser beam corresponding to respective color component based on write time setting information set thereto. The write time setting information 5a is corrected appropriately in accordance with deviation information obtained by executing later mentioned positioning operation.

Positioning use pattern data in the storage area 5b is used to form an image of a positioning use pattern to be formed on the conveyance belt 1002 as shown in FIG. 12.

An image formation accumulation page number Ptotal is stored in the storage area 5c. A value currently stored there is 0010952, and indicates that the image formation apparatus 1 has printed totally 10952 times of printing onto recording sheets. The Ptotal is incremented in a sequence as shown in FIG. 7 as mentioned later in detail.

Information of time Tlast that represents a time when the image formation apparatus 1 lastly executes a detection performance correction operation is stored in the storage area 5d. As a time Tlast, a numeral number 200412221010 is currently stored. Specifically, time information “AM10:10, Dec. 22, 2004” is stored.

Information of an image formation accumulation page number Plast produced by the image formation apparatus 1 until when the detection performance correction operation is lastly executed is stored in the storage area 5e. As a page number Plast, 0010900 is currently stored. Specifically, a number of 10900 sheets are stored.

In the storage area 5f, a value of flag Fmode is stored as a flag to set a mode that starts a detection performance correction operation. The value 0 represents that a detection performance correction operation is started subject to determining a condition of an elapsing time. The value 1 represents that it is determined based on an accumulation number of pages.

In a storage area 5g, a setting value (e.g. a duty ratio) set when a detection performance correction operation is previously executed is stored as a previous detection performance correction setting value Dprevious. Data of 50% is currently stored therein.

In a storage area 5h, a value (e.g. minute) of a current set elapsing time Tset is stored.

Data of 60 minutes is currently stored therein.

In a storage area 5i, a value (e.g. a number of sheets) of a currently set accumulation page number Pset is stored. Data of 500 sheets is currently stored therein.

In the storage area 5j, a value of detection performance correction operation waiting flag Fwait is stored. The value 0 of the flag Fwait represents a condition that a detection performance correction operation is not waited to start. The value 1 represents a condition that it is waiting for starting as mentioned later in detail.

In the storage area 5k, a detection performance correction operation start condition setting table is stored.

Now, the detection performance correction operation start condition setting table 5k is specifically described with reference to FIG. 4.

In the table 5k, a difference “delta D” between a setting value (e.g. a duty ratio) set when a detection performance correction operation is previously executed and that set when a detection performance correction operation is currently executed is classified into ranges from more than zero to not more than 5%, from more than 5 to not more than 10%, from more than 10 to not more than 15%, and more than 15%. The table 5k includes settings of various times (e.g. minute) for elapsing time mode use and various page numbers for accumulation page number mode use assigned to respective ranges. Each of the elapsing time mode and the accumulation page number mode is designated by the flag Fmode of the storage area 5f.

The settings of the table 5k are determined considering that an interval of staring the detection performance correction operation can be relatively long when the difference delta D is relatively small, i.e., progress of stein of the background of the conveyance belt 1002 is relatively slow. In contrast, the interval can be relatively short when the progress of the stein is relatively fast.

Now, a sensor I/F circuit 1030 included in the image formation section 9 of FIG. 12 is specifically described with reference to FIG. 5.

The sensor I/F circuit 1030 is employed for each of the mark detection sensors 1021, 1022, and 1023.

A PWM signal generator 2001 holds a PWM setting value Spwm output from the CPU 2 via the system bus 14 within its interior register, and outputs a PWM wave (a square wave) having a duty ratio corresponding to the PWM setting value Spwm. The PWM signal generator 2001 can set a duty ratio at a resolution, such as ten bit, twelve bit, etc., in a range from 0 to 100%.

The PWM wave output from the PWM signal generator 2001 is input to an integration circuit (e.g. a smoothing circuit) 2002, and an input PWM like direct current voltage is output in proportion to the duty ratio.

The direct current voltage output from the integration circuit 2002 can directly be supplied to light emission diode D that constitutes a mark detection sensor 1021 (1022, 1023). However, since it is more suitable to control an amount of supply current when controlling an intensity of the light emission diode, an input voltage is converted into a direct current in proportion thereto via a voltage/current conversion circuit 2003 to be supplied to the light emission diode D.

An intensity controlled light outgoing from the light emission diode D is emitted to the surface of the conveyance belt 1002 and causes a reflection light in accordance with a reflectivity of a background or each mono color mark.

The reflection light from the conveyance belt 1002 is input to a photo transistor Ptr that constitutes a mark detection sensor 1021 (1022, 1023). The photo transistor Ptr changes its resistance in accordance with the reflection light, the change of resistance is amplified by an amplifier circuit 2004 and is output as a voltage change amount. A noise component of a high frequency of the voltage is removed by a filter circuit 2005, and is input to an A/D converter 2006 to be converted into digital data. The thus converted digital data is referred to by the CPU 2 via a FIFO memory 2007 and the system bus 14.

Then, as shown in FIG. 14, a PWM setting value Spwm of the PWM signal generator is adjusted so that a voltage level (i.e., a background level) obtained by reading a background of the conveyance belt 1002 by means of the mark detection sensor 1021 (1022, 1023) becomes 4 volt when an input voltage of the A/D converter 2006 ranges from 0 to 5 volt. After that, a mark formation position is determined by comparing a voltage varying during reading of positions of the respective marks of FIG. 13 with a threshold level (e.g. 2 volts).

However, since a detected background level changes owing to stein of the background, the PWM setting value Spwm need to be adjusted again, i.e., a detection performance correction operation need to be executed. It is insufficiently considered conventionally how often such a detection performance correction operation is executed, and a detection performance correction operation shown in FIG. 6 is conventionally executed.

As shown in FIG. 6, a conventional positioning operation is described. Specifically, the positioning operation controls a correction operation to start correcting write time setting information stored in a storage area 5a. That is, a pattern is formed on a conveyance belt 1002 and is detected by a plurality of detection sensors 1021, 1022, and 1023. Then, positional deviation currently caused between respective component colors both in the main and sub scanning directions, as well as deviation in a write start time for the respective colors in the main scanning direction are corrected based upon the reading and detection result.

As shown, a positioning start condition meet monitoring operation (step S101) is repeated unless a condition is met (No, in step S102)). If the condition is met (Yes, in step S102), a detection performance correction operation (step S103) is always executed before a positioning operation starts in step S104.

The positioning operation of step S104 needs a prescribed time period to form and read a pattern while driving the conveyance belt 1002. The detection performance correction operation of step S103 also needs a prescribed time period to read a background of a surface of the conveyance belt 1002 and correct a detection performance (i.e., adjustment of a duty ratio setting value: Spwm) while driving the conveyance belt 1002.

Even though a condition of starting the positioning operation depends upon an operational condition of an apparatus. However, the condition can be completion of printing of one case document file that includes one or more document data, a prescribed time interval, completion of printing of a prescribed accumulation number of printing document files, and completion of printing of a prescribed accumulation number of printing pages.

In any way, however, a productivity of the image formation apparatus decreases and a user need to waist a time if a detection performance correction operation needlessly starts every when the positioning operation starts.

The detection performance correction operation is required to precisely execute the positioning operation. However, the detection performance correction operation is originally to maintain a detection performance of detecting a background by adjusting a variation in the detection performance caused as time elapses, and is not necessarily executed together with the positioning operation as a pair. However, if a frequency of the detection performance correction operation is optimized, the productivity and waist of time can be improved and suppressed.

Then, an image formation apparatus 1 executes a prescribed sequential operation according to one embodiment of the present invention.

Specifically, an exemplary sequence of updating accumulation image formation page number is executed in the image formation apparatus 1 as shown in FIG. 7.

As shown, when image formation of one page is monitored (No, in step S201) and is completed, an accumulation image formation page number Ptotal in the storage area 5c is incremented by one in step S202. The sequence then returns to step S201.

Thus, an accumulation number of pages from when the image formation apparatus 1 starts operation to now can be known if the accumulation page number Ptotal (the initial value is zero) stored in the storage area 5c is referred to.

Now, a detection performance correction operation executed in step S605 during a positioning operation start control operations executed by the image formation apparatus 1 as described later with reference to FIG. 11 is described with ref FIG. 8.

Also, a positioning operation executed in step S606 during the positioning operation start control sequence executed by the image formation apparatus 1 as mentioned later with reference to FIG. 11 is described with reference FIG. 9.

First, as shown in FIG. 8, a background of the conveyance belt 1002 is detected by the detection sensors 1021, 1022, and 1023 in step S301. The conveyance belt 1002 is driven during the detection performance correction operation, and accordingly, the background is widely read and detected.

Then, by reading in step S301, it is determined if a detection voltage level (i.e., a background level) obtained from the sensor I/F circuit 1030 is a reference voltage of 4.0 volt having a permission range (e.g. ±0.1 volt). In such a situation, a PWM setting value Spwm set in the previous detection performance correction operation as an optimum value is set to PWM signal generator of the sensor I/F circuit 1030.

Then, it is determined if it is within the permission ranged in step S303. If the determination positive (Yes, in step S303), the sequence immediately goes to step S307.

In contrast, if a change in the level of stein of the background is larger than before (No, in step S303), it is further determined if the detection voltage level is more than the reference level (and out of the permission range) in step S304. If the determination is positive (Yes, in step S304), a duty ratio output from the PWM signal generator 2001 is slightly decreased by slightly decreasing the PWM setting value Spwm so as to slightly decrease light intensity of the light emission diode D and the detection voltage level in step S305. Then, the sequence returns to step S301.

If the determination is negative, i.e., the detection voltage level is less than the reference level and out of the permission range (No, in step S304), a duty ratio output from the PWM signal generator 2001 is slightly increased by slightly increasing the PWM setting value Spwm so as to slightly increase light intensity of the light emission diode D and the detection voltage level in step S306.

Then, the sequence returns to step S301.

In any way, by repeating the determination in steps S301 to S306, the determination in step S303 become positive (i.e., Yes). A PWM setting value Spwm serves as an optimum setting value for a current level of stein of the background of the conveyance belt 1002 at that time point, and is maintained by the PWM signal generator 2001 until being changed. Specifically, the positioning operation of FIG. 9 is executed with the optimum detection performance.

Back in step S303, if the determination becomes positive (i.e. Yes), a prescribed operation is executed for the later mentioned detection performance correction operation start control described with reference to FIG. 10.

Specifically, a lastly set duty ratio Dcurrent is set as a current PWM setting value Spwm, and a difference delta D (e.g. an absolute value) between the Dcurrent and a previous detection performance correction setting value Dprevious stored in the storage area 5g is calculated in step S307. Then, the delta D and the table 5k are compared. Then, an elapsing time and an accumulation page number are set as currently set values corresponding to the delta D in step S308. Specifically, these elapsing time and accumulation page number are set and stored in the storage areas 5h and 5i as a currently set elapsing time Tset and a currently set accumulation page number Pset, respectively. Steps S307 and S308 are sequences in which the currently set elapsing time Tset and the currently set accumulation page number Pset are set to prescribed values corresponding to a progressing speed of background stein on the conveyance belt 1002 in the image formation apparatus 1. Specifically, they are set larger and smaller when the speed is higher and lower, respectively.

Further, the lastly set duty ratio Dcurrent is stored by updating the storage area 5g in step S309 as a new previous detection performance correction setting value Dprevious for the next detection performance correction operation in step S307.

Further, a current time Tnow is read and obtained from a timer circuit 6 in step S310, and is stored by updating the storage area 5d as a value of a time Tlast that represents a time when a detection performance correction operation is lastly executed in step S311.

Similarly, an accumulation image formation page number Ptotal is read from the storage area 5c in step S312, and is stored by updating the storage area 5e as an accumulation image formation page number Plast representing a time when a detection performance correction operation is lastly executed in step S313.

Now, a positioning operation is described with reference to FIG. 9. A positioning use pattern shown in FIG. 13 is formed on a background of the conveyance belt 1002 in step S401 based on the positioning use pattern data of storage area 5b while driving the conveyance belt 1002. Then, the detection sensors 1021, 1022, and 1023 detect marks formed by respective color components in the pattern. As a result of the detection, a deviation amount of an image formation position currently caused in the image formation section is obtained in step S402.

In step S402, since a detected background level has been corrected to fall within a permission range having a reference level (e.g. 4 volts) at its center by the detection performance correction operation of FIG. 8 as shown in FIG. 14, positional deviation can be precisely detected.

Then, in order to counterbalance the positional deviation amount obtained in step S402, contents of write time setting information of the storage area 5a is rewritten instep S403. Specifically, a write time and a write frequency are corrected in both the main and the sub scanning directions per color component.

Thus, image formation can be executed without color deviation after that.

It is most preferable in a sense to maintain precision of the detection performance if the detection performance correction operation of FIG. 8 is executed every time right before the positioning operation of FIG. 9. However, the detection performance correction operation needs a prescribed time as mention earlier, it is preferable to decrease the frequency execution thereof to a prescribed level not to largely affect the precision of the detection performance.

Thus, the image formation apparatus 1 employs a detection performance correction operation start control sequence that controls a frequency of the detection performance correction operation to be the minimum as shown in FIG. 10.

Specifically, as shown, it is determined if a value of a flag Fmode set and stored in the storage area 5f is either Zero (representing an elapsing time) or No (representing an accumulation page number) in step S501.

If the value is zero (Yes, in step S501), the timer circuit 6 is read and a current time Tnow is obtained in step S502. Then, it is determined if a difference between the current time Tnow and a time Tlast representing a time when the detection performance correction operation is lastly executed exceeds a value Tset stored in the storage area 5h in step S503.

If the determination result is negative (No, in step S504), the sequence returns to step S501 without executing any operations. If the determination result is positive (Yes, in step S504), the numeral number 1 is set to the flag Fwait stored in the RAM 4 in step S505, and the sequence returns to step S501.

Back in step S501, if the value of the flag Fmode is the numeral number 1 (i.e. the accumulation page number) (I.e., No), the accumulation image formation page number Ptotal is read from the storage area 5c in step S506. Then, it is determined if a difference between the Ptotal and an accumulation image formation page number Plast representing a page number when the detection performance correction operation is lastly executed exceeds a value Pset stored in the storage area 5i in step S507.

If the determination result is negative (No, instep S508), none of operations are executed and the sequence returns to step S501. If the determination result is positive (Yes, in step S504), the numeral number 1 is set to the flag Fwait stored in the RAM 4 in step S505, and the sequence returns to step S501.

Instead of setting the numeral number 1 to the Fwait in step S505, the detection performance correction operation of FIG. 8 can be executed.

In such a situation, the detection performance correction operation can be started and executed at an optimum frequency in accordance with a signal indicating a background stein speed.

However, if the detection performance correction operation is executed right before a positioning operation firstly executed after a condition of starting the detection performance correction operation is met, a positional deviation is most precisely detected without increasing a frequency of starting the detection performance correction operation.

Thus, the numeral number 1 is set to the Fwait instep S505 instead of starting the detection performance correction operation.

The value of the flag Fwait is referred to in a positioning operation start control operation sequence of FIG. 11 in the image formation apparatus 1.

Specifically, a condition of the positioning operation start is continuously monitored until the condition is met (in step S601, No, in step S602). If the condition is met (Yes, in step S602), it is determined if the value of the flag Fwait is either the numeral number 1 or 0 in step S603.

If the determination result is the numeral number 0 (No, in step S603), since the condition of starting the detection performance correction operation is not met, only the positioning operation is executed as shown in FIG. 9 in step S606, and the sequence returns to step S601.

In contrast, If the determination result is the numeral number 1 (Yes, step S603), since the condition of starting the detection performance correction operation is met, the value of the flag Fwait is returned to the numeral number 0 in step S604, and the detection performance correction operation and the positioning operation are executed as shown in FIGS. 8 and 9 in steps S605 and S606. The sequence then returns to step S601.

Thus, since the detection performance correction operation is not immediately executed even when the condition of starting detection performance correction operation is met and is delayed until a time right before the positioning operation is firstly started after that, detection precision of the positioning operation can be improved as much as possible while maintaining a frequency of the detection performance correction operation.

Numerous additional modifications and variations of the present invention are possible in light of the above teachings. It is therefore to be understood that within the scope of the appended claims, the present invention may be practiced otherwise that as specifically described herein.

What is claimed is:

1. An image formation apparatus comprising:
a write control device configured to control a laser beam to form at least two latent images of component colors on at least two photoconductive members arranged in parallel to each other corresponding to respective component colors based on write time setting information stored in a memory;
a color image formation device configured to form a color image by developing the at least two latent images and transferring and superimposing those onto a transfer sheet conveyed by a conveyance member traveling in a photoconductive member arrangement direction;
a positioning toner pattern forming device configured to form a positioning toner pattern including at least two marks corresponding to the color components on the conveyance member;
a mark detection device configured to detect each of the marks;
a positioning operation control device configured to control a positioning operation of correcting color deviation caused between the component colors by changing the write time setting information based on the detection result of the mark detection device;
a detection performance correction operation control device configured to control the mark detection device to read a background of the conveyance member, said detection performance correction operation control device correcting the detection performance of the mark detection device so as to obtain a prescribed reference level from the background; and
a start control device configured to control the positioning operation control device to start the positioning operation when a prescribed positioning operation start condition is met, said start control device controlling the detection performance correction operation control device to start operation when a prescribed detection performance correction operation start condition different from the positioning operation start condition is met.

2. The image formation apparatus according to claim 1, wherein said mark detection device includes a light emitting element and a light receiving element, said light receiving element receiving a light generated by the light emitting element and reflected by the background, and wherein the detection performance correction operation control device corrects the detection performance of the mark detection device by change intensity of the light emitted from the light emitting element.

3. The image formation apparatus according to claim 1, further comprising an elapsing time threshold storing device configured to store at least one elapsing time threshold, and wherein said detection performance correction operation start condition is met when the elapsing time threshold has been elapsed after the last detection performance correction operation is executed.

4. The image formation apparatus according to claim 1, further comprising an elapsing time threshold storing device configured to store at least one elapsing time threshold, and wherein said detection performance correction operation start condition is met when the elapsing time threshold has been elapsed after the last detection performance correction operation is started and the positioning operation start condition is firstly met, and wherein the start control device controls the detection performance correction operation control device to operate before starting the positioning operation control device.

5. The image formation apparatus according to any one of claims 3 and 4, further comprising:
a detection performance setting value storing device configured to store a setting value related to a detection performance, said setting value being corrected and updated each time when the detection performance correction operation is executed; and
a threshold elapsing time setting value changing device configured to compare both currently and previously corrected setting values and change the threshold elapsing time in accordance with a difference between the both currently and previously corrected setting values.

6. The image formation apparatus according to claim 1, further comprising a threshold page number storing device configured to store a threshold page number, and wherein said detection performance correction operation start condition is met when the threshold page number of images are formed by the image formation device after the detection performance correction operation is lastly executed.

7. The image formation apparatus according to claim 1, further comprising a threshold page number storing device configured to store a threshold page number, and wherein said detection performance correction operation start condition is met when the image formation device has formed the threshold page number of images after the detection performance correction operation is lastly executed and the prescribed positioning operation start condition is firstly met, and wherein said start control device starts the detection performance correction operation control device to operate before starting the positioning operation control device.

8. The image formation apparatus according to any one of claims 6 and 7, further comprising:
a detection performance setting value storing device configured to store a setting value related to a detection performance, said setting value being corrected and updated each time when the detection performance correction operation is executed; and
a page number setting value changing device configured to compare both currently and previously corrected setting values and change the threshold page number in accordance with a difference between the both currently and previously corrected setting values.
